(19) United States
(12) Patent Application Publication
(10) Pub. No.: US 2011/0050985 A1
(43) Pub. Date: Mar. 3, 2011

(54) SYSTEM FOR ARTIFICIALLY IMPROVING CONTRAST FOR DISPLAYING IMAGES

(76) Inventor: José Muñoz Leo, Malpica Tajo (ES)

(21) Appl. No.: 12/532,092

(22) PCT Filed: Mar. 19, 2007
(86) PCT No.: PCT/ES2007/070059

§ 371 Date: Jan. 5, 2010

(51) Int. Cl. H04N 5/222; G03B 21/20; G03B 15/02

(52) U.S. Cl. 348/370; 353/85; 396/180; 348/E05.022

(57) ABSTRACT

A system for artificial enhancement of contrast in image visualization may include at least one illumination source that emits short light pulses in a divergent beam, an optical system which forms an output image from the light reflected by objects that have been illuminated, a device which selectively blocks during specific time intervals the output image of the system, and an electronic system for synchronizing the instants of time when the illuminating pulses are emitted as well as when the output images are blocked.

### CROSS REFERENCE TO RELATED APPLICATIONS AND PRIORITY CLAIM

This application claims the benefit under 35 U.S.C. §371 to PCT/ES2007/070059 filed Mar. 19, 2007. The entire disclosure of said application is incorporated herein by reference thereto.

### BACKGROUND

The ability to detect or identify targets during the observation of scenes with conventional optical instruments or closed-loop television systems is highly interesting for application in many fields such as civil protection, rescue, military and police operations scientific research, etc. In contrast with observation systems based on thermal imaging cameras, where targets in a scene such as objects or personnel emit detectable radiation, visualizing non-emitting targets with TV systems based on near infrared, or shorter wavelength sensors, requires partial reflection by targets in the scene towards the observation system of the light emitted by some illumination source, either natural or artificial. The same situation takes place when visualization is made with a human eye assisted by conventional lens-based optical instruments. The capacity to detect and identify objects with these conventional observation systems is limited under low luminance conditions. In these low luminance conditions, adding an image intensifier to the observation system, such as those used in passive night vision systems, improves visualization and allows for extending the ranges of detection and identification. When the objects in the observed scene do not receive enough illumination, it may also be possible to illuminate with an auxiliary artificial source. Artificial illumination allows more light reflected by the objects to be received, thus improving the signal-to-noise ratio regardless of whether the system includes an image intensifier or not. However, in situations where the scene to be observed includes intense spotlights as well as passive targets a large, not always available, dynamic range may be required in the detector, in order to avoid a contrast loss among objects in the vicinity of the spotlight due to saturation of the camera sensors or image intensifier. In this situation, the detection and/or identification ranges may be significantly reduced. One possible approach in this case may be attenuating the signal level on the detector, thus avoiding saturation in the detector by using filters, reducing the auxiliary illumination level, or by other alternative approaches. In so doing, the light received in the sensor from weakly illuminated objects may be significantly diminished, thus reducing the signal-to-noise ratio and making non-discernible those objects which received light is close to or under the noise equivalent power of the system.

Another adverse situation takes place when an object mimics its surroundings, making its detection or identification difficult, if not impossible.

Presently, for military operations, research is in progress both for improving mimic uniforms and for screening the heat emitted by personnel or vehicles. Research is also currently in progress to apply diffractive techniques for thermal radiation screening, based on a similar principle as that used by some types of butterflies to change the color of their wings without involving pigments.

A mimic uniform that would also avoid heat emission outside, would allow for hiding targets to observation systems based on thermal imaging cameras as well as to conventional observation systems.

The presence of partially reflecting placed between the observation system and some object in the scene also is an adverse observing condition in many cases. When the illumination of the object to be observes must go through the partially reflecting surface, the observation system receives simultaneously and spatially overlapped reflections. The object may even be indiscernible against the background of light reflected by the various surfaces. The same situation arises when the light reflected by the object is superimposed against a background of light reflected by a light scattering layer, such as smoke, fog, hard rain, or, for example, superimposed to the light coming from fire placed between the observation system and the object.

### BRIEF DESCRIPTION OF SOME EXAMPLE EMBODIMENTS

It is desirable to introduce improvements in conventional observation systems that would increase their detection and identification ranges under adverse conditions, or would allow for visualizing thermally screened targets undetectable with observation systems based on thermal imaging cameras.

Some example systems described in the present specification may satisfy this need to a great extent. These example systems may improve the detection and identification ranges for objects or personnel observed with a conventional optical system or a close-loop television system under adverse conditions, or where observation with conventional optical or thermal systems becomes difficult or impossible.

One example system is based on the combination of pulsed illumination and a device that inhibits image formation. The example system may include at least, the following elements:
A source of pulsed light, for example, a laser or a light emitting diode. The short-duration illumination pulses are emitted as a divergent beam in a solid angle, in order to transiently illuminate the objects placed within said solid angle. A fraction of the illuminating pulse gets reflected towards the observation system by the objects placed within the illumination solid angle.
An optical or catadioptric assembly which receives the light reflected by the illuminated objects and forms their image. In some examples, this assembly have a variable focal length that can be controlled by electrical motors or other types of apparatus, thus allowing for focusing at a variable distance and allowing for depth of field control.
A device which selectively inhibits the output of images from the observation system. This device should enable an output image only during determined time intervals. It can be, for example, an optoelectronic, electro-optic or acousto-optic device, or a liquid-crystal based device. Inhibiting may be accomplished, for example, with an optoelectronic image-transferring device comprising a two-dimensional photosensitive sensor and a luminescent or electroluminescent screen. The optical assembly may focus the image on the sensor where an electrical signal carrying information of the image may be generated. Regardless of its internal mechanisms this device may generate a replica on the screen of the image focused on its sensor. The image may displayed in a variety of manners, for example, an image on the screen can be viewed either with the naked eye, through an eyepiece, or picked up by a TV camera and displayed on a monitor. In particular, using an image intensifier as the image inhibiting device provides the advantage of luminance gain in the observation system
An electronic unit providing exploration and system synchronization that controls the time instants of the illumination pulse emissions and their optical energy. The electronic unit may also, an adjustable time delay, trigger the enabling of images for an also adjustable time interval in order to control a range of distances where the reflecting objects placed within said range may appear in the image, and avoiding any reflection from objects placed outside the range of distances set by the time delay and time interval described. In this manner, the image of the illuminated objects placed within the correct range of distances set by the time delay and the time interval may appear surrounded by a black background in the image, with their contrast enhanced. By means of a suitable exploration using different values of time delay and time interval, information can be obtained about objects located in different planes. Thus, the system may receive enough information to create a three-dimensional representation of the objects placed within the illumination solid angle. It then becomes possible to learn the individual distance to the observation system of the objects, for example, using electronic processing.

Some example variations that may improve the operating characteristics of the example system may include having the output image picked-up by an electron tube TV camera, or by a solid-state camera having a two-dimensional CCD or CMOS sensor, which may then displayed on a TV monitor. An electronic unit can be added to improve the image generated in the camera prior to displaying it on the monitor in order to improve the image quality or to emphasize some characteristics of interest for detection and identification of objects, such as edge enhancement, smoothing, additional contrast enhancement, setting a threshold level, etc.

### BRIEF DESCRIPTION OF THE DRAWINGS

FIG. 1 illustrates an example system using a human eye as the final sensor, according to an example embodiment of the present invention.

FIG. 2 illustrates schematically an example system using a TV camera as the final sensor and a monitor to display the images, according to an example embodiment of the present invention.

### DETAILED DESCRIPTION OF EXAMPLE EMBODIMENTS

Some example embodiment of the present invention include systems that enhance contrast in observation systems that use two-dimensional light sensors such as television cameras (TV) or the human eye itself. Some of the example systems may extend the ranges of detection and identification of objects or personnel under adverse observing conditions by avoiding or significantly reducing the loss of contrast and quality of observed images caused by degrading effects arising from the presence of intense spotlights, reflecting surfaces, or light scattering layers in the observed scene. Some of the example systems may use an auxiliary external illumination source, to artificially modify the contrast among objects in the image, thus increasing the detection and identification ranges as compared with conventional observation systems.

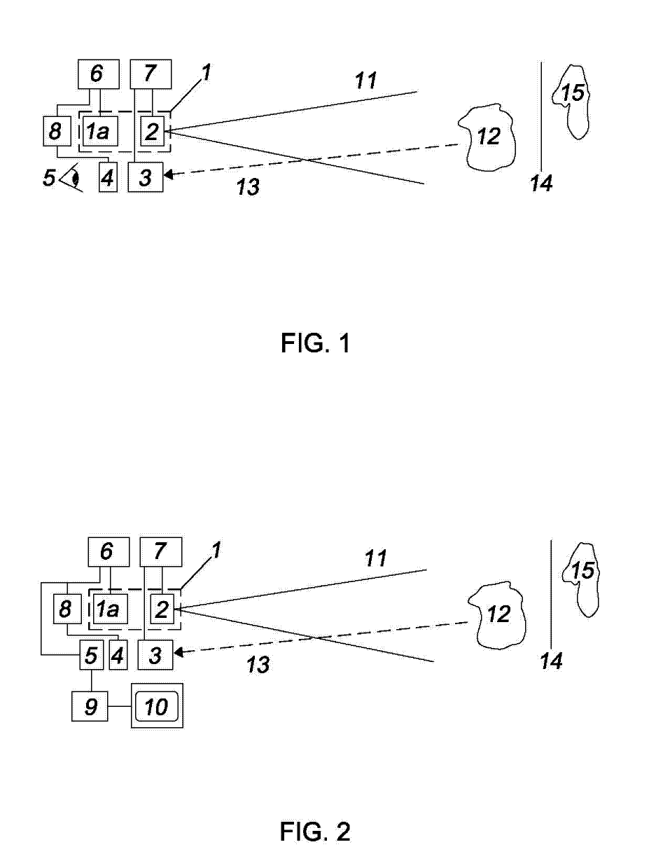

FIG. 1 illustrates an example system using a human eye as the final sensor, according to an example embodiment of the present invention. The example system may include an illumination source 1 that emits short duration pulses in a divergent beam. The illumination source may include a laser la that generates the short duration illumination pulses in a highly collimated beam, and a aiming/expanding optical assembly 2. The collimated laser beam is incident on the optical assembly 2 which introduces divergence in the illumination beam and allows for controlling both the amount of divergence and the aiming direction of the illumination beam 11. This may be accomplished with a suitable assembly of movable lenses or minors, with their positions controlled using electrical motors. Alternatively, an assembly of lenses having refractive characteristics that can be modified with an electric signal may be used. In both cases, the system may also include a control unit 7 for the optical assembly 2.

When a part of the illumination beam reaches an object 12 placed within the illuminated solid angle 11, a fraction of light 13 of the illumination pulse may be reflected towards an optical assembly 3 that forms an image of the object or objects illuminated. This optical assembly may include a set of lenses resulting in a variable focal length, e.g., a zoom or a telephoto, that allows adjustment of the focusing distance of the assembly and/or the depth of field. This may be accomplished with electrical motors that modify the relative positions of the lenses within the assembly using electrical motors or by using optical elements with refractive characteristics that can be altered via an electric signal. In both cases the system may include the control of the optical assembly 3 in the electronic unit 7.

The image formed by this assembly is focused on a detector, e.g., the photocathode of an image intensifier tube 4 which creates a replica of the image on its phosphor screen. This image from the screen can be considered as an output image and can be directly visualized with the naked eye 5 in drawing 1, or the image may be passed through an eyepiece to provide a more relaxed visualization. The image intensifier tube may perform as the inhibiting device. The output image may remain inhibited most of the time by maintaining a reverse bias—opposite to that required for normal operation—in the photocathode. In this way, the photoemission process required for image formation during normal operation of the image intensifier remains inhibited for a time interval. Normal bias is then re-established for a short time interval using an electronic control unit 6 that controls the timing and synchronization of the system. During the time intervals when photoemission is enabled, an image may be transferred from the photocathode to the screen accompanied by an adjustable gain in luminance, characteristic in this kind of devices. For increasing the gain, an intensifier that includes at least one microchannel plate inside is preferred because besides providing additional gain, it allows for overall gain control through control of the bias voltage of the plate. The electrodes of the photocathode may need to be externally accessible in order to establish the photoemission enabling/inhibiting processes (gating), and the power supply of the intensifier may need to incorporate an external connection to control its gain. In order to switch the photocathode biasing, which involves high voltage signals, an electronic unit 8 in drawings 1 and 2 may be added to the system, e.g., a commercially available gating unit controlled using a low-voltage control signal. The rise time for switching the photocathode on/off may affect the ability of the observation system for range discrimination. A rise time not exceeding 5 nanoseconds may be preferred. In order to observe scenes where personnel are present, it may be convenient that the photocathode of the image intensifier has a good quantum efficiency in the infrared spectral range considered eye-safe, allocated above 1500 nanometers. In this manner, the illumination source can be made to emit intense light pulses in the same spectral range without representing a potential hazard risk for the eyes of the personnel situated within the illumination field of the system. The persistence of the phosphor screen of the image intensifier needs to be neither too short nor too long. Because the system may operate sometimes with enabled image transmission intervals of a few nanoseconds, a certain amount of persistence would help in keeping the eye or camera receiving a signal for a longer time. On the other hand, a long persistence time may limit the speed of response of the system for moving objects. A good compromise is achieved with a P43 phosphor in the screen of the intensifier, which has a characteristic decay time (persistence) of around one millisecond. Moreover, the peak emission in this kind of phosphor takes place at in the green spectral range, which is advantageous when observing the screen by a human eye, or to pick-up the image with a silicon-based solid-state camera which sensitivity peak normally matches this spectral range.

The use of an image intensifier presents the additional advantage of providing a high gain and a low noise figure. Therefore it may perform in an optimal manner as a first amplifying stage concerning the final noise figure of the complete should more amplifier stages be added, according to the well-known Friis formula.

Alternatively, as already mentioned above, the image generated on the screen of the intensifier may be transferred to a TV camera 5 in drawing 2, either using optical coupling or using a coherent fiber optic bundle having a high number of individual fibers. In the latter case, it may be convenient that the output window of the intensifier be of the fiber-optic kind. The electrical signal generated in the camera may then be directly displayed on a TV monitor 10 in drawing 2, or alternatively be introduced into an electronic processing unit 9 in drawing 2 prior to be sent to the monitor, or even to introduce simple processing functions that ease detection and recognition such as border enhancement, quantification of the luminance in discrete levels, setting a luminance threshold, inverse video, etc.

The electronic synchronization unit 6 in drawings 1 and 2 may employ a timing clock (time base) of 50 or 60 cycles/second, in order to provide an unnoticeable blinking of the image, and to make it compatible with standard video and TV systems. The clock signal may trigger the emission of the illumination pulses in a periodic manner, one per clock cycle. Unavoidably, a small delay—typically a few hundred microseconds—may result between the leading edge of the illumination trigger pulse and the actual emission of the light pulse. Internal to this unit, there is a delay unit (not explicitly) represented in the drawings) which receives the clock signal from the time base and generates a new version of the periodic clock signal with a voltage level suitable to control the gating unit 8, and with a delay and duty cycle that can be adjusted by the user of the observation system. If the range of distances to be observed with the system should start at zero distance from the observation system, the minimum delay in the modified clock signal may need to match the one needed to trigger the actual emission of the illumination pulse and the effective enabling of photoemission to occur at the same instant. The adjustable value for the delay may determine the minimum value of the closest object to the system that can be visualized. The adjustable duty cycle may then determine the maximum distance for which the system may be able to visualize objects. Therefore, the minimum and maximum distances of observation can be user selected.

Thanks to the inhibiting action of the image intensifier and to the pulsed character of the illumination source, the transmission of an image to the final sensor element (eye or TV video camera) may be controlled so that the light received in the sensor corresponds only to light reflected by the objects placed within a range of distance to the system comprised between c×Te/2 and (Te+ΔT)×c/2, where c stands for the speed of light, Te for the time interval elapsed between the emission of the illumination pulse and the enabling of the image intensifier, and where AT is the time interval in which internal image transmission is enabled in the image intensifier. The factor 2 in the formulas accounts for the go-return path that requires the illumination to travel to the object, be reflected, and then travel back again to the system. In order to perceive a continuous observation with no appreciable blinking, either with an eye or with a camera, the illumination source may emit pulses in a periodic manner, with a convenient (although not necessary) minimum pulse repetition rate of 25 cycles/second. The pulse repetition frequency of the illumination pulses (fr in what follows) may be the clock frequency at which the system may operate, and may be provided by a suitable electronic time base for a correct synchronism in the system.

In this manner, the passing of the image through the intensifier may also take place in a periodic manner, during the ΔT time intervals. The distance D between the system and the nearest observed plane may then be determined by D=c×Te/2, and the depth of the illuminated field PC—distance between the nearest and farthest planes observed by the system—may be PC=c×ΔT/2. The light emitted by the source which is reflected by the objects or scattering media located outside the range of distances D+PC may find its way through to the system sensor inhibited.

If the objects in the scene to be observed reflect light coming from an illumination source external to the system, or if any of the objects emits light itself towards the system, a total inhibition of this light reaching the sensor cannot be accomplished and it may contribute to the image with an integrated power (energy) of Pm×ΔT, with Pm being the mean power received in the system during the time interval ΔT.

The example system described here may, through a suitable choice of Te and ΔT, be capable forming an image on the system sensor of a very narrow range of distances, and located at a specific distance from the system, thus discriminating the objects that fall outside a selected range of distances to the observation system. This ability may allow for a considerable increase in detection and identification of objects in the disclosed system as compared with other conventional observation systems.

If a small value of ΔT is selected, a constant or slowly varying intensity spotlight pointing to the system with an average light intensity power value Pe the sensor may receive a mean power also constant or slowly varying of value Pe×ΔT×fr. For example, if ΔT=40 ns and fr=25 cycles/second, the mean optical power received on the sensor from the spotlight would be one million times lower than the one it would receive if operating in a continuous way. As a result the spotlight may be seen by the system with an apparent intensity one million times lower than its real intensity, opposite to what would happen in any other conventional observation system. Under normal circumstances conventional light sources would hardly produce saturation of the sensor in the disclosed system, nor the associated loss of contrast. This same attenuation factor would result for the light reflected by the objects observed and which are illuminated by a typical non-pulsed external light source.

On the other hand, pulsed laser sources can emit very intense light pulses concentrated in very short time intervals. Continuing with the former example, an object of similar size and form of the spotlight, located at the same distance to the system, and illuminated with 40 nanoseconds pulses by the system laser source, would need to reflect towards the sensor a mean power similar to that of the spotlight during the time interval AT to appear as bright to the system as when illuminated with the spotlight. This represents in general a very low energy in the laser pulse. If we denote with P_{IR} the power reflected towards the observation system by an object illuminated with the pulsed laser light of said system, then the total light (luminous energy) received in the system during the time interval ΔT, corresponding to the exemplified object may be Po=(P_{R}+P_{IR})×ΔT, where P_{R} represents the average power of the external or ambient illumination light reflected by the object towards the system (or emitted by the object in case of being a spotlight). Taking into account that in a scene uniformly illuminated by the laser P_{IR}=P_{B}+R, where P_{B} is the pulsed light received by the object and R its reflection coefficient for the system illumination, and given that P_{B} is in general much higher than P_{R}, the system may operate with similar performance under daytime and nighttime (P_{R}=0) ambient illumination, and the image formed in the system may essentially match the two-dimensional distribution of the reflection coefficient of the objects at the system laser wavelength.

On the other hand, the effective reflection coefficient can be made zero for objects placed outside the range of distances associated to ΔT, appearing in the image as darkness, thus improving the contrast among the edges of the objects placed within ΔT and those that are not, therefore easing their detection and identification. In the same way, any object placed closer to the system that the distance at which interval ΔT starts, may appear as a shadow in the image, also easing its detection and shape identification.

When an object (target in what follows) is placed in front of other objects of similar reflection coefficient, and one of the edges (or them all) that limit the target is viewed against a background formed with those other objects a mimic or camouflage situation results. With a suitable choice of the value of Te, so that its value is adjusted for the observation distance where the target is placed, the reflection of the objects that mimic the target can be inhibited, and the target edges may appear well defined against a dark background. It is also possible to adjust Te to the distance where the farther away objects which help for camouflage of the target are located. In this case, the light reflected by the farther objects may be seen in the image, but with a shadow due to the light blocked by the target, thus being discernible the shadow of the target in the image.

It is also possible to visualize through a partially reflecting surface 14 in drawings 1 and 2, behind which the target 15 in both drawings is located. Effectively, because the surface is only partially reflecting, it may reflect light towards the system but it may also transmit a portion of the laser illumination light aiming at the target which may continue to propagate, reach the target, and be back reflected towards the system Part of that light reflected by the target may make its way back through the surface 14.

In the preceding specification, the present invention has been described with reference to specific example embodiments thereof. It may, however, be evident that various modifications and changes may be made thereunto without departing from the broader spirit and scope of the present invention as set forth in the claims that follow. The specification and drawings are accordingly to be regarded in an illustrative rather than restrictive sense.

1-16. (canceled)

17. A system for artificial enhancement of contrast in image visualization, comprising:
an illumination source that is configured to emit short duration light pulses in a divergent beam;
an imaging assembly configured to create an output image of an object illuminated by the illumination source; and
an electronic synchronization device configured to selectively enable and inhibit the formation of an output image by the imaging assembly during determined time intervals that are selected so that objects at a particular range of distances at least one appear highlighted in the image o r have their contrast enhanced.

18. The system of claim 17, wherein the imaging assembly is an optical imaging assembly.

19. The system of claim 17, wherein the imaging assembly is a cadiatropic imaging assembly.

20. The system of claim 17, wherein the illumination source providing the divergent beam includes at least one of a laser or a light emitting diode, and wherein said illumination source emits light pulses of less than 30 nanosecond duration.

21. The system of claim 20, wherein the illumination source further includes an aiming/expanding assembly

22. The system of claim 21, wherein the aiming/expanding assembly further includes at least one of a lens-based optical system or a catadioptric system.

23. The system of claim 21, wherein the aiming/expanding system is configured to vary relative position of optical elements using electronically controlled electrical motors.

24. The system of claim 21, wherein refractive characteristics of lenses in the aiming/expanding system can be varied to adjust at least one of the divergence or aiming direction of the illumination responsive to an electric signal.

25. The system of claim 17, wherein the imaging assembly includes a variable focal length set of lenses configured to adjust the focusing distance and depth of field of the imaging assembly.

26. Thee system of claim 17, further comprising a device that enables/inhibits the formation of an output system image under control of the synchronization device, the device being at least one of an optoelectronic device, an electro-optic device, an acousto-optic device, or a liquid-crystal based device.

27. The system of claim 26, wherein the device is at least one of an image intensifier tube or a cascaded assembly of more than one image intensifier.

28. The system of claim 17, further comprising:
a two-dimensional photosensitive and luminescent screen, the imaging assembly being configured to cause the output image to be generated on the luminescent screen by focusing the image formed by the imaging assembly on the screen.

29. The system of claim 17, further comprising a TV video camera configured to pick the image and communicate it to be displayed on a monitor.

29. The system of claim 29, further comprising an electronic processor configured to process the image prior to the image being displayed on the monitor.

31. The system of claim 20, wherein the illumination source is a laser that emits light with a wavelength equal or longer than 1500 nanometers.

32. The system of claim 20, wherein the system includes an image intensifier tube with “extended infrared response” configured to operate efficiently in a spectral range of wavelengths above 1500 nanometers.

32. The system of claim 32, wherein the screen of the image intensifier has a preferred persistence of a few milliseconds.

33. The system of claim 32, wherein the screen of the image intensifier uses a P43 phosphor.

34. The system of claim 27, wherein coupling of an image between the image intensifier tube and the camera takes place by electron bombardment on the sensor elements of the camera, thus integrating the image intensifier and the camera sensor in a single device.

35. The system of claim 27, wherein the image intensifier includes at least a microchannel plate that increases the gain of the image intensifier and allows for controlling said gain using a bias voltage of said microchannel plate.

36. The system of claim 27, wherein the electronic synchronization device is configured to control on/off switching of the image intensifier.
